(19) United States
(12) Patent Application Publication
(10) Pub. No.: US 2006/0286949 A1
(43) Pub. Date: Dec. 21, 2006

(54) Frequency sweeping receiver

(76) Inventor: Kazuyoshi Imazeki, Tokyo (JP)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/157,641

(22) Filed: Jun. 21, 2005

(51) Int. Cl. H04B 1/18

(52) U.S. Cl. 455/161.3

(57) ABSTRACT

A frequency sweeping receiver is provided for locating a target signal having the greatest strength of the signals received by the receiver. The receiver includes circuitry which performs a sweeping operation to receive a plurality of input signals, one at a time. The strength of the input signals is compared to a pre-determined threshold value to identify input signals to be captured. Upon identifying the input signals to be captured the sweeping operation is halted and data about the input signal is stored in memory. A decision circuit then identifies which of the captured signals has the greatest strength and identifies this signal as the target signal. Upon identifying the target signal, information regarding the target signal is stored in memory. The rate of said frequency sweeping is set to compensate for the delays inherent in the receiver filters, and signal detection circuitry, such to cause the received signal to be centered in the passband of the receiver upon the cessation of the frequency sweep. The receiver can later be tuned to the target frequency by recalling the frequency from memory rather than performing another sweeping operation.

### BACKGROUND OF THE INVENTION

This invention relates to a frequency sweeping receiver or scanner radio. A frequency sweeping receiver is a receiver having the feature of tuning to a range of frequencies and halting sweeping if a target frequency is received. The target frequency can be that one with the strongest signal, which usually is the one that is being broadcast by the transmitter closet to the receiver.

The user of a conventional scanner radio sometimes desires to listen to the signal provided by a nearby transmitter e.g. a fire truck passing by. In order to locate the signal, the scanner sweeps a range of frequencies and upon locating a frequency upon which a signal is being transmitted, sweeping of the frequencies is stopped. The first signal located, however, often is not the target frequency, i.e. the frequency of the fire truck that is passing by. Rather, sometimes the located signal is transmitted from another nearby source. The user must then provide an indication to the receiver that the target signal has not been located and direct the scanner to continue scanning to locate the target signal. Because a large number of signals may be located prior to locating the target signal, a certain amount of time may be used before the target signal is located. If too much time is needed to locate the target signal, the signal may be gone before the user is able to locate it, i.e. the fire truck has left the area.

There have historically been two methods of sweeping frequencies, the analog sweeping method and the digital sweeping method.

An analog method of sweeping frequencies typically is performed by varying the frequencies to which the receiver is tuned by varying a VCO (voltage-controlled oscillator) control voltage in a triangular-like or saw-tooth-like waveform, and furthermore influencing the VCO control input by the output of a frequency discriminator upon receiving a signal. The result is an automatic frequency control (AFC) circuit. Thereafter, fine reception tuning is performed based on the AFC function.

This simple method however, is not suitable for a receiver required to sweep a wide frequency band. If the receiver is to sweep a wide frequency band, the possibility that multiple frequencies will be present in the band increases, such that there may be occasions that the first received signal is not the target frequency. In such an occasion, the receiver should continue to sweep frequencies that have not been swept yet. However, when an analog sweeping method is used, it is difficult for the receiver to implement a feature capable of storing the frequency where the band has previously been swept, such to then avoid that undesired frequency on subsequent sweeps.

A digital frequency sweeping method sweeps frequencies using a built-in phase-locked loop (PLL) frequency synthesizer. It receives all frequencies at set discrete intervals (e.g., 6.25 kHz, 15.0 kHz, etc.), irrespective of actual signal presence. The reception operation includes tuning, waiting for PLL lock and checking the signal. Thus the reception operation, and associated undesirable delay, will be performed even for frequencies where no signals are present. Because this digital method requires synchronization (or locking) of the PLL frequency synthesizer for every frequency, considerable time is often required to find the target signal.

### OBJECTS AND SUMMARY OF THE INVENTION

An object of the invention is to provide a frequency sweeping receiver which can identify which signal received by the receiver is the target signal.

Another object of the invention is to quickly identify the target signal.

Yet another object of the invention is to store data regarding the target signal in memory so that the receiver can be tuned to the target signal without performing an additional sweeping operation.

Still another object of the present invention is to correct frequency error when tuning to the target signal after a sweeping operation has been interrupted due to the detection of a target signal.

A further objection of the present invention is to eliminate the need for automatic frequency control in some instances.

In an exemplary embodiment of the invention, the circuit determines which signal is the target signal by first measuring the strength of the received signals. The received signal is passed through an intermediate frequency amplifier and a second signal having its voltage proportional to the strength of the received signal is provided. Data relating to the received signals is stored in memory. Frequency sweeping is performed by using a voltage-controlled oscillator whose control signal tunes the receiver through a range of frequencies. A decision circuit is used to identify which of the received signals is the strongest, i.e. the target signal.

### BRIEF DESCRIPTION OF THE DRAWINGS

FIG. 1 is an electrical block diagram of a preferred embodiment of the frequency sweeping circuit.

FIG. 2a is a time-frequency diagram which relates to the frequency sweeping circuit of FIG. 1 and represents a condition when automatic frequency control is not required.

FIG. 2b is a time-frequency diagram which relates to the frequency sweeping circuit of FIG. 1 and represents a condition when automatic frequency control is required.

FIG. 3 is a schematic diagram which relates to the block diagram of FIG. 1.

### DETAILED DESCRIPTION OF THE PREFERRED EMBODIMENT

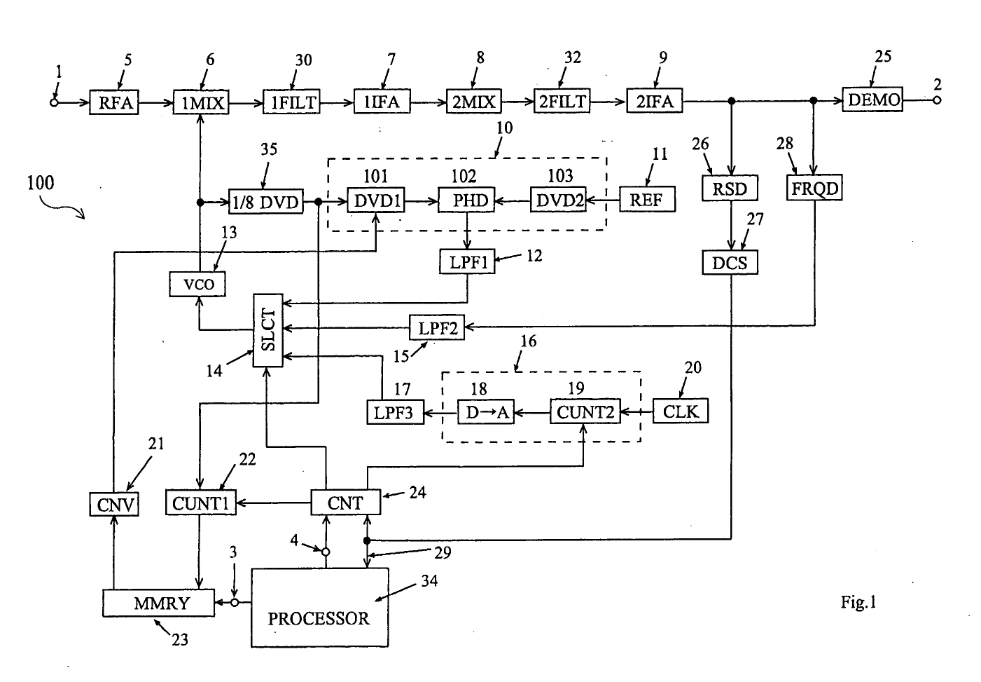

A block diagram which represents the tuning portion 100 of the frequency sweeping receiver of the present invention is shown in FIG. 1. As shown in FIG. 1 the circuit 100 includes a radio frequency signal input terminal 1, a demodulation signal output terminal 2, a directional terminal 3, a control signal input terminal 4, and control terminal 29.

A received signal is applied to radio frequency signal input terminal 1 and is amplified by a radio frequency amplifier 5. The amplified signal is then applied to a first frequency mixer 6. The output signal from the first frequency mixer 6 is then provided to a first filter 30. The output signal from the first filter 30 is applied to a first intermediate frequency amplifier 7. The output signal from the first intermediate frequency amplifier 7 is then provided to a second frequency mixer 8. The output signal from the second frequency mixer 8 is then provided to a second filter 32. The output signal from the second filter 32 is applied to a second intermediate frequency amplifier 9. The output signal from the second intermediate frequency amplifier 9 is then coupled to a demodulation circuit 25 where the signal is demodulated and passed to a demodulated signal output terminal 2 and to a microprocessor 34.

Frequency sweeping is performed by using a voltage-controlled oscillator 13 operating as a first local oscillator to tune the receiver to a range of frequencies. The control signal of the voltage controlled oscillator 13 is generated by a sloped waveform generating circuit 16. The sloped waveform generating circuit 16 includes a counter 19, a digital to analog converter 18, and a low-pass filter 17. Clock pulses generated from a clock signal generator 20 are applied to the counter 19 to increase the counter 19 at a constant rate. The output signal of the counter 19 is applied to a digital-to-analog converter 18. The digital to analog converter 18 converts the signal to a stepwise analog voltage signal which is then passed through a low-pass filter 17 to provide a clean sloped waveform. If the steps of the analog voltage signal of the digital to analog converter 18 are sufficiently small, the low-pass filter 17 is not required. Alternatively, rather than counting clock pulse using the counter 19 to obtain a stepwise wave form, pulses can be accumulated by an accumulator to obtain a stepwise waveform.

A tuner is provided by the radio frequency amplifier 5, the frequency mixers 6, 8, the filter 32, the intermediate frequency amplifiers 7, 9, the sloped waveform generating circuit 16, and the voltage controlled oscillator 13. The sloped waveform generating circuit 16 provides the control voltage to drive the voltage-controlled oscillator 13 through a selective circuit 14 to sweep a frequency band. Consequently, when a received radio frequency signal is passed through the intermediate frequency amplifier (7 and/or 9), the tuner generates an output signal having its voltage proportional to the strength of the received signal. The tuner output signal is provided to a receive signal strength detector 26. Some of the general purpose integrated circuits provided within the circuit 100 include output terminals called receive signal strength indicators or S-meters which provide an indication of the strength of the received signal. The voltage of the tuner output signal is continuously monitored via a decision circuit 27. The decision circuit 27 determines “signal presence” and is adjustable to the desired threshold level to identify the signals to be captured. When the decision circuit 27 determines that the signal meets or exceeds this threshold level, a decision circuit output signal is sent from the decision circuit 27 to identify the captured signal. The decision circuit output signal is sent to a control signal generator 24 which in turn sends a signal to the counter 19 to halt the counting operation of the counter 19. Upon halting of the counter 19, the sweeping function of the VCO 13 is halted and a counter 22 counts the frequency of the output signal of the voltage-controlled oscillator 13 and stores the counted results in a memory 23. Because the signal closest to the receiver will likely have the greatest strength, the target signal can be identified by determining which of the captured signals has the greatest strength. The output signal of the decision circuit 27 is also provided through the control terminal 29 to the microprocessor 34 to provide an indication that the sweeping function has been halted. The directional terminal 3 provides communication between the microprocessor 34 and memory 23. Terminal 4 provides communication from the microprocessor to the control signal generator 24. If the microprocessor 34 determines that the captured signal is not the target frequency, the microprocessor 34 sends a signal to the memory 23 to store data regarding the frequency of the captured signal where sweeping halted. The microprocessor 34 also sends a signal to control signal generator 24 through terminal 4 to continue to sweep other frequencies. The circuit 100 is capable of selecting whether the sweeping operation begins from zero or resumes from its halted accumulated value. The frequency sweeping operation is a repetitive process. When the circuit 100 sweeps the entire frequency range of interest, multiple stops and memory store cycles may occur. Therefore, when the circuit 100 is configured to start the sweep over again, new signals which were not present during the prior sweep may be found. The frequency sweeping operation can be repeated several times per second.

If the captured signal has the greatest strength and therefore is the target frequency, the circuit detects the frequency and stores it as the target frequency in memory 23. Thus, when it is desired to receive the target station again, the terminal 3 is used to recall the target frequency from the memory 23 and the phase locked loop synthesizer 10 is directly configured such that the target station is received by the circuit 100. By recalling the target frequency, the circuit 100 is directly configured to receive the target signal without performing a sweeping operation.

By having the counted result of the target frequency stored in a memory 23, the circuit 100 is able to receive the captured signal again, by reading out the stored result in memory 23, and converting this value to codes using a code converter 21. The code converter 21 can be, for example, either a microprocessor or lookup table provided in a memory chip. The input signal provided to the code converter 21 is the saved frequency valve counted from counter 22, and the output signal is a PLL divider word which is provided to the first frequency divider 101 of a phase lock loop synthesizer 10 to cause the PLL synthesizer 10 to set the VCO 13 through low pass filter 12 and selective circuit 14 to the same frequency that was previously swept and counted by counter 22.

The bandwidth of the first intermediate frequency filter 30 is usually far wider than the bandwidth of the second intermediate frequency filter 32. Also an added signal having the same frequency as the center frequency of the first intermediate frequency is usually converted through the second frequency converter into a signal having the same frequency as the center frequency of the second intermediate frequency. Therefore the effect on the signal passing through the two filters are as follows: the group delay time equals the sum of delay time of two filters and the characteristics of the second intermediate frequency filter 32 has a decisive effect on the band selectivity.

The phase locked loop synthesizer 10 is a general purpose integrated circuit and is represented by a dashed box in FIG. 1. The phase locked loop synthesizer 10 includes the first frequency divider 101, a phase detector 102, and a second frequency divider 103. The second frequency divider 103 divides the output of a reference oscillator 11 which is used as frequency reference. The phase detector 102 compares outputs of both the first frequency divider 101 and the second frequency divider 103. The output of the phase detector 102 drives the voltage-controlled oscillator 13 through a low-pass filter 12 and the selective circuit 14.

The resultant intermediate frequency signal provided by the second intermediate frequency amplifier 9, is not always set to a correct center frequency of the filter 32 due to the time delay of the filters 30, 32 since the VCO 13 is sweeping. Thus, the resultant intermediate frequency includes frequency error. If, however, the frequency error is not so large, the frequency detector 28 does not detect the frequency error due to its small size, and the circuit can usually be used without automatic frequency control.

When the frequency error is large, the frequency detector 28 detects the frequency error and automatic frequency control is required.

To perform normal demodulation operation, the circuit is configured as follows. An automatic frequency control loop is selected by the selective circuit 14, such that the frequency error is detected by a frequency detector 28 and is allowed to influence VCO 13. The frequency detector 28 provides a frequency- to-voltage converter such as a frequency discriminator, whose output drives the voltage-control oscillator 13 through a low-pass filter 15 and the selective circuit 14. In this manner, the voltage control oscillator 13 can be converged or influenced to a correct frequency that will center the received signal in the filter 32 for undistorted reception.

As mentioned earlier, an automatic frequency control selected by the selective circuit 14 may be required if a frequency error remains present. Generally, while sweeping frequencies when the receiver halts sweeping upon detecting a signal, a frequency error usually remains present. However, automatic frequency control is not required, if the rate of the sloped waveform generating circuit 16 is matched to the various delays in the low pass filter 17, the VCO 13, the intermediate frequency filters 30, 32, and the delay within the signal strength detector 26. When such a condition exists, time adjustments are intrinsically provided and the need for automatic frequency control is eliminated.

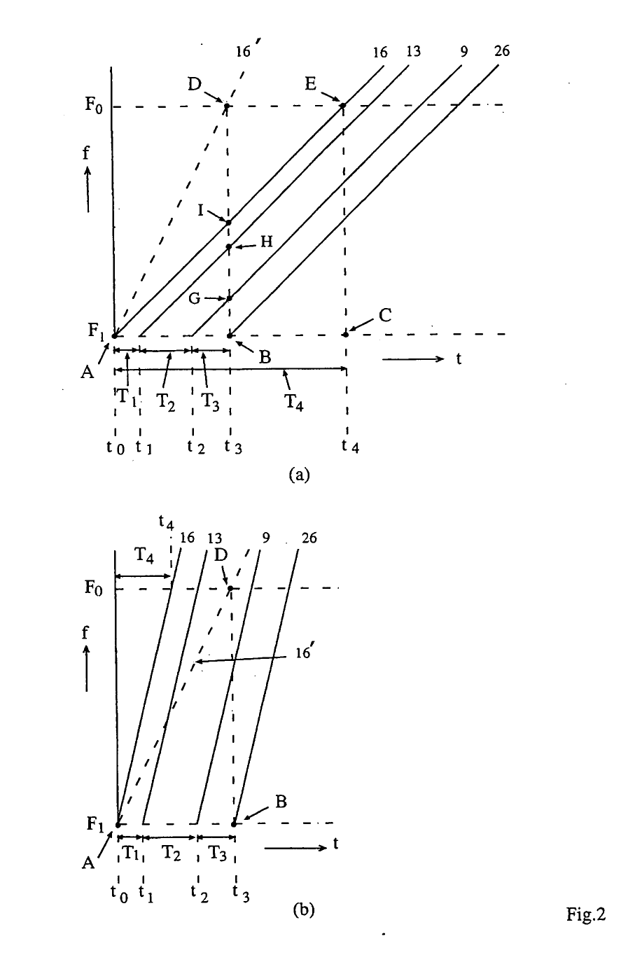

FIGS. 2a and 2b represent two sweeping cases, T₁+T₂+T₃<T₄ and T₁+T₂+T₃>T₄ using a graphical representation in the band. T₁ represents group delay time in the passband of the low-pass filter (17) for smoothing stepwise waveforms; T₂ represents group delay time of the IF filter 32; T₃ is the required detecting time of a receive signal strength detector (26); and T₄ is the time to sweep from the lower limit frequency of the passband of the IF filter 32 to the center frequency of the passband of the IF filter 32. In both FIGS. 2a and 2b, the X-axis represents time and the Y-axis represents frequency. F₀ denotes the center frequency of IF filter 32. F₁ denotes the lower limit frequency of the IF filters 32. In FIG. 2, diagonal line 16 denotes the sweep status of the sloped wave form generator 16. Diagonal line 13 represents the output frequency of the voltage controlled oscillator 13. Diagonal line 9 represents the output signal of the second intermediate frequency amplifier 9. Diagonal line 26 represents the output signal from the receive signal strength detector 26.

Referring to FIG. 2a, in the case of T₁+T₂+T₃<T₄, the time-to-frequency relationship at each point is indicated when the sweep speed is (F₀−F₁)T₄. The time t₃ when the decision circuit 27 turns active is indicated as point B. At this time, the output of the second intermediate frequency output has already reached the frequency of point G, the second intermediate frequency input and VCO output has already reached the frequency of point H (by neglecting the group delay time from VCO output to the second intermediate frequency input) and the sloped waveform generator 16 output has already reached the voltage corresponding to the frequency of point I. The sloped wave form generator 16 output has already generated the voltage corresponding to the lowest frequency F₁ of the second intermediate frequency passband time (T₁+T₂+T₃) previous to t₃, that is, at t₀, the output should be at the point backward along the slope of (F₀+F₁)/T₄ from point I, which is shown as point A. The sloped waveform generator 16 output reaches the voltage corresponding to the center frequency of the second intermediate frequency band in t₄ from point A, which is shown as point E. The diagonal line 16 through points A and point E indicates a graph of the sloped waveform generator 16 output. The output signal of the VCO 13 varies along the diagonal line 13 time T₁ delayed from the diagonal line 16, and the signal with time delay T₂ appears as the second IF filter 32 output. This is indicated as diagonal line 9. The output time T₃ delayed from the diagonal line 9 becomes the receive signal strength detector 26 output. The output of the receive signal strength detector 26 operates the decision circuit DCS 27 at point B. Therefore, when the decision circuit 27 turns active with the signal time T₁+T₂+T₃ delayed from input of the filter, if the sloped waveform generator 16 output is at F₀, the diagonal line appears as 16′ instead of 16. In this case of matching the sweep speed to the circuit delays, automatic frequency control. (AFC) becomes unnecessary. On the other hand, it is apparent from FIG. 2(a) that, instead of making sweep speed higher, if point B is delayed to point C, that is, the receive signal strength detector 26 output is delayed to t₄, the sloped waveform generator 16 output appears at F₀ and AFC also becomes unnecessary.

Referring to FIG. 2b, in the case of T₁+T₂+T₃>T₄, which is to the inverse case of FIG. 2a, it is apparent from FIG. 2b that when line 16′ becomes a more gradually sloped line than shown by line 16 by decreasing sweep rate, if frequency sweep halts on detecting a signal, the intermediate frequency signal comes just at the center frequency of the filter 32, which becomes the same case as FIG. 2a resulting in making automatic frequency control (AFC) unnecessary.

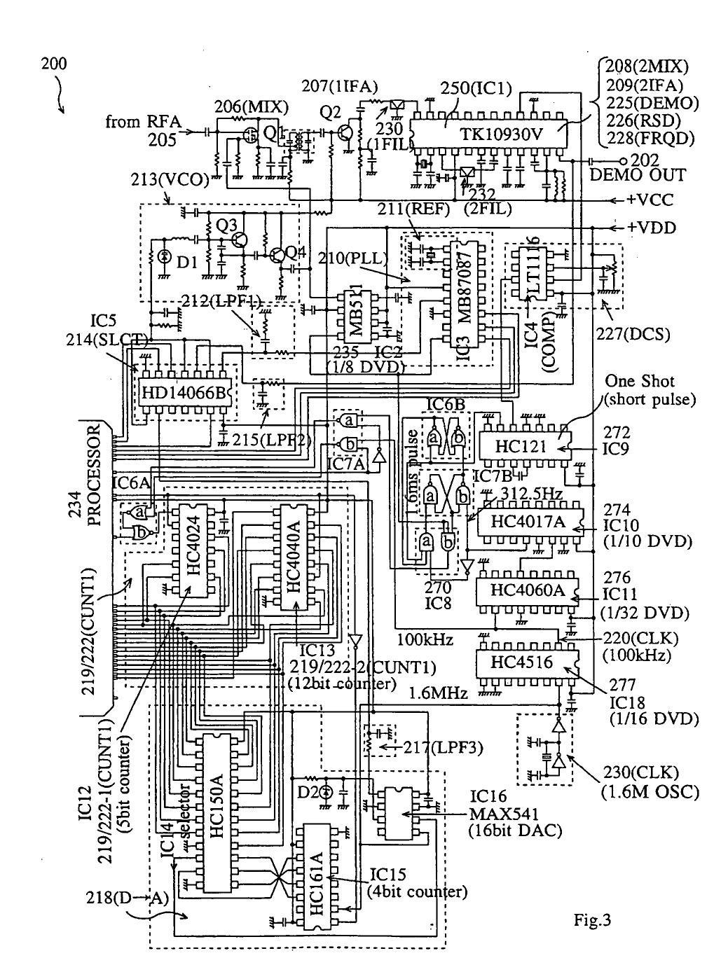

Further details of the circuit 100 are shown in FIG. 3. A signal received from a radio frequency amplifier 205 is a applied to frequency mixer 206, amplified by a first intermediate frequency amplifier 207 and carried to an integrated circuit 250. Integrated circuit 250 includes a second frequency converter 208, a second intermediate frequency amplifier 209, a demodulation circuit 225 where the signal is demodulated and passed to a demodulated signal output terminal 202, and a signal generating circuit 226 for receiving signal strength indication.

Integrated circuit 235 is a pre-scaler (1/8 divider).

PLL frequency synthesizer integrated circuit 210 includes a reference signal generator 211 for a PLL frequency synthesizer 210, a frequency divider 101, 103 and a phase detector 102.

Decision circuit 227 includes integrated circuit 256, which is a comparator for determining received signal strength.

Portion 213 of the circuit 200 provides a voltage-controlled oscillator (VCO).

Portion 212 of the circuit 200 provides a low pass filter.

Integrated circuit 214 is an analog switch for selecting VCO control input.

Portion 215 of the circuit 200 provides a low pass filter.

Integrated circuit 219/222-1 and integrated circuit 219/222-2 comprise a common-use counter in two-stage configuration, between whose outputs the counter switches using integrated circuit 119 and integrated circuit 122. The circuit comprising integrated circuit IC6B, IC7B, integrated circuit 270, integrated circuit 272, integrated circuit 274 and integrated circuit 276 is a reference pulse generating circuit for counting VCO frequency through the pre-scaler 235. Integrated circuit 272 is a mono-stable circuit. Integrated circuit 274 and integrated circuit 276 comprise a frequency divider in two-stage configuration.

We will explain the operation using values for an example for one of ordinary skill in the art to make or use the invention.

If we let T₁+T₂+T₃ be 80μ seconds and IF's bandwidth be 15 kHz, it is required for a signal to stay in the bandwidth 15 kHz for more than 80μ seconds to detect the signal. Therefore the sweep speed is set to 10 kHz/60μ seconds because kHz/80μ seconds=10 kHz/53.33μ seconds. If 100 MHz bandwidth is swept in this speed, 100 MHz×60μ seconds/10 kHz=0.6 seconds is required. As mentioned earlier, the stepwise waveform to make the VCO perform this sweeping counts 100 kHz clock on the line 220(CLK) using the counters 219-1 and 219-2 to convert its output into analog voltage through a digital to analog converter. To perform this digital to analog conversion, if sweep stays for sufficient time of 10μ second on one step of stepwise waves, the total number of steps becomes 0.6 s/10μ seconds=60000. The clock signal frequency of 100 kHz is determined by this 10 μs. When using 16 bit, as required number of the counter is 2¹⁶=65,536, a 16-bit counter should be used. This 100 kHz clock signal is obtained by frequency-dividing the 1.6 MHz clock signal generator 230(CLK) output by 1/6 through IC18 277.

The 100 kHz clock signal of this frequency-divided output is provided to two-staged counter comprising of counters 219-1 and 219-2 through IC7A-b and IC6A-a for counting. The counting result is taken out using 16 parallel outputs and then applied to the digital to analog convert 218. The digital to analog converter is comprised of a data selector IC14, 4 bit counter IC15, and 16 bit digital to analog converter IC16. 16 parallel input data from the counter 219 is provided to the data selector IC14 and this select voltage is determined by 4-bit data of the counter IC15. The 4-bit counter IC15, which is operated by the clock signal generator 230(CLK) output of 1.6 MHz, needs just 10μ seconds to count 16 counts. Therefore, within one step of the stepwise waveform just 16-bit parallel data is read out as parallel data, and converted into analog voltage through the 16-bit digital to analog converter IC15. The analog voltage, through the low path filter 217(LPF3) and the analog switch 214(SELECT), drives the voltage controlled generator 213(VCO) to perform frequency sweeping.

When a signal is received during this frequency sweeping, if the decision circuit 227 determines signal strength of the received frequency is more than any predetermined value, integrated circuit 272(IC9) mono-stable multi-vibrator generates a short pulse of output. The length of this pulse is not required to be accurate because the pulse is used to generate the next reference pulse. In this example, the length of the generated reference pulse is 1.6 milliseconds, which is used as a frequency counting reference for measuring VCO frequency when the signal was received.

This value of 1.6 milliseconds is determined by the following reason: When it is assumed that the allocated interval of the RF frequency is 12.5 kHz, VCO frequency measuring error of ±5 kHz is allowed when a signal is received, and the highest frequency to be measured is 500 MHz, a counter which can count 500 MHz/5 kHz=100,000 counts within ⅕ kHz=200μ seconds may be required. However, in reality, a general purpose IC counter operable at 500 MHz is not available. Alternatively, instead of decreasing to 500 MHz/8=62.5 MHz using a 1/8 frequency-divided pre-scaler, the method of octuplicating counting time, that is, 1.6 milliseconds can be adopted. This is the reason why 1.6 milliseconds is adopted, provided that 1/8 frequency-divided pre-scaler and 17 bit (217=131072) counter are used.

The above indicates that it is sufficient for the counter to count 1.6 millisecond portion of the 62.5 MHz pre-scaler output.

To perform this, a 1.6 millisecond gate pulse is required, which is, as previously mentioned, generated from the mono-stable multivibrator output of 272(1C9) as follows: IC18 277 frequency-divides 1.6 MHz to gain the clock signal of 100 kHz, which is then frequency-divided into the ratio 1/32 through IC11 276 (1/32 DVD), which is again frequency-divided by the ratio 1/10 through IC10 274 (1/10 DVD) to gain 312.5 Hz. Because the half cycle of 312.5 Hz signal is 1.6 milliseconds, if output appears on IC9 272, the output has only to generate the half cycle signal of 312.5 Hz signal. This operation is performed by the flip-flop circuit IC6B, IC7B and IC8. IC8a is a driving circuit for IC7B and IC8b is a gate circuit which extracts 1.6 millisecond portion of 1/8 frequency-dividing pre-scaler output. An 1.6 milliseconds pulse is a flip-flop IC6B output toggled by the mono-stable multivibrator output, which drive the flip-flop IC7B through the AND gate IC8a and then is ANDed with 1.6 ms pulse through the AND gate IC8a, resulting in correct 1.6 millisecond pulse at the flip-flop circuit IC7B.

As mentioned previously, 1.6 millisecond portion is extracted from 1/8 frequency-dividing pre-scaler output, which is counted by IC12 222-1 and IC13 222-2 counters through IC7Aa, IC6Aa, and IC6Ab, whose count value is read out and stored by PROCESSOR 234. (These counters are called Counter 219-1 and 219-2 respectively when generating stepwise waveforms to sweep VCO.) Later, when a signal of the same frequency is received, the stored value is read out from PROCESSOR 234 and the required frequency-dividing ratio for the frequency-divider DVD 101 of the PLL Synthesizer is gained. The value is converted into the frequency-dividing ratio to set the frequency divider DVD1 101.

Portion 218 of the circuit 200 is a digital to analog converter which converts output of the counter 219/222 into analog voltage. Integrated circuit IC14 is a selection circuit for selecting one of sixteen (16) inputs. Integrated circuit IC14 is a 4-bit counter for determining the selection number of integrated circuit 214. Integrated circuit IC16 is a digital to analog converter for serial input. Portion 217 of the circuit 200 provides a low pass filter.

Portion 230 of the circuit 200 provides a clock.

The circuit 200 sweeps frequencies properly under the control of a microcomputer CPU 280. When a signal is captured, the count value of the VCO frequency at this time is stored. At a later time, in order to reset VCO to this frequency using the stored count value, CPU is only required to have a conversion software which converts the count value into a value gained by dividing the VCO frequency by the reference frequency.

The invention claimed is:

1. A circuit for tuning a receiver to a plurality of signals each having different frequencies and determining which signal is the target signal, said circuit comprising;
means for sweep tuning said receiver to a plurality of radio frequency input signals;
means for measuring the strength of said plurality of radio frequency input signals;
means for detecting which ones of said plurality of radio frequency input signals exceed a predetermined threshold strength, to thereby determine captured signals;
means for halting said tuning upon detection of each captured signal;
means for storing data about each of said captured signals;
means for determining which of said captured signals has the greatest signal amplitude to thereby identify a target signal;
means for converting said target signal to an audio signal.

2. A circuit as defined in claim 1, wherein said means for sweep tuning includes a voltage controlled oscillator which receives a signal from a counter through a digital to analog converter.

3. A circuit as defined in claim 2, wherein said means for sweep tuning further includes a low-pass filter to receive said signal from a digital to analog converter.

4. A circuit as defined in claim 1, further including means for storing data about said target signal.

5. A circuit as defined in claim 4, further including means for recalling said data about said target signal and means for configuring said circuit to receive said target signal without performing further tuning.

6. A circuit as defined in claim 1, further including means for detecting frequency error.

7. A circuit as defined in claim 6, wherein said means for detecting frequency error includes a frequency discriminator which performs frequency detection of intermediate frequencies.

8. A circuit as defined in claim 1, further including means for correcting frequency error.

9. A circuit as defined in claim 8, wherein the means for correcting frequency error includes adjusting the rate of frequency sweep of the local oscillator signal by a factor, wherein said factor is determined to be the factor required to accommodate the cumulative delays of the receiving and signal detection circuits such that the initial detection of the signal will occur when the target signal is centered in the intermediate frequency bandwidth of the receiver.

10. A circuit for tuning a receiver to a plurality of signals each having different frequencies and for determining which of said signals is a target signal said circuit comprising:
a radio frequency signal input terminal for receiving a plurality of radio frequency input signals;
a tuner for examining each said signal and generating a corresponding signal strength signal;
a decision circuit to receive said corresponding signal strength signals and to determine which of said signal strength signals are greater than a predetermined threshold strength to then identify a plurality of captured signals;
a memory for storing said captured signals;
a detector coupled to said memory to determine which of said plurality of captured signals has the greatest strength, to identify a target signal.

11. A circuit as defined in claim 10, wherein said tuner includes a sloped waveform generating circuit for providing a control signal to a voltage controlled oscillator.

12. A circuit as defined in claim 11, wherein said sloped waveform generating circuit includes a counter.

13. A circuit as defined in claim 11, wherein said sloped waveform generating circuit includes an accumulator.

14. A circuit as defined in claim 11, further including a control signal generator which receives a signal from said decision circuit and wherein upon identification of a captured signal, said decision circuit provides a signal to said sloped waveform generating circuit to halt the generation of said sloped waveform.

15. A circuit as defined in claim 10, further including a central processing unit for storing data about said captured signals and said target signal.

16. The circuit as defined in claim 15, wherein the frequency of said captured signals and said target signal is stored in said central processing unit.

17. The circuit as defined in claim 16, wherein said central processing unit further includes an input terminal and wherein upon setting said input terminal said frequency of said target signal is recalled from said central processing unit and the input signal of said voltage controlled oscillator is provided by said central processing unit.

18. The circuit of claim 10, frequency sweeping receiver of claim 10, further including a counter and a switch for placing said counter in either a frequency sweeping mode or a measuring mode, wherein said counter provides a control signal to said voltage controlled oscillator in said frequency sweeping mode and said counter generates a signal for measuring the frequency of the output of the voltage controlled oscillator in said measuring mode.

19. A circuit as defined in claim 10, further including a frequency error detection circuit.

20. A circuit as defined in claim 19, wherein said frequency error detection circuit includes a frequency to voltage converter whose output drives said voltage controlled oscillator.

21. A circuit as defined in claim 10, further including a frequency correction circuit.

22. A circuit as defined in claim 21, wherein said frequency correction circuit includes circuitry configured to adjust the output signal by a pre-determined time delay.
